(19) United States
(12) Patent Application Publication
(10) Pub. No.: US 2004/0081465 A1
(43) Pub. Date: Apr. 29, 2004

(54) System and method for supplying power to media converters for optical communication

(76) Inventors: Jong-Kwon Kim, Taejon-Kwangyokshi (KR); Dong-II Seo, Pohang-shi (KR); Yun-Je Oh, Yongin-shi (KR); Seong-Taek Hwang, Pyongtaek-shi (KR)

Correspondence Address: Steve S. Cha, Esq., CHA & REITER, 9TH FLOOR, 411 HACKENSACK AVE, HACKENSACK, NJ, 07601, US

(21) Appl. No.: 10/645,189

(22) Filed: Aug. 21, 2003

(30) Foreign Application Priority Data
Sep. 18, 2002 (KR) 2002-57000

(51) Int. Cl. H04B 10/00

(52) U.S. Cl. 398/116

(57) ABSTRACT

Disclosed is a system and method for supplying driving power to media converters for optical communication, which can realize a communication system employing a simple circuit construction at a minimal expense even in the case where the communication system includes a plurality of media converters. Each media converter converts an interface of an electrical-communication device to an interface of an optical-communication device and converts the interface of the optical-communication device to the interface of the electrical-communication device. The system includes: a power-supply device constructed independently from the media converters; and, at least one power-supply socket device to supply power from the power-supply device to the media converters.

### CLAIM OF PRIORITY

This application claims priority to an application entitled “System for supplying power to media converters for optical communication,” filed in the Korean Intellectual Property Office on Sep. 18, 2002 and assigned Serial No. 2002-57000, the contents of which are hereby incorporated by reference.

### BACKGROUND OF THE INVENTION

1. Field of the Invention

The present invention relates to a system for supplying power to media converters for optical communication, wherein the media converters convert an interface of an electrical-communication device to an interface of an optical-communication device or converts the interface of the optical-communication device to the interface of the electrical-communication device.

2. Description of the Related Art

Recently, the Ethernet, which has been the basis of a local area network (LAN), increased its applied fields to the Metropolitan Area Network (MAN) and Wide Area Network (WAN). Due in large part to this success is that the Ethernet can efficiently use a link bandwidth, has improved functions, and can supply cheap equipment through mass production. Accordingly, concern with respect to the efficient use of previously-installed devices has been also increasing. However, most devices having an electrical interface, such as switches or routers, can not transmit mass data over a long distance due to features of its transmission line. Accordingly, there is a need for a media converter that can convert an electrical interface to an optical interface capable of being transmitted over long distances and then converting the optical interface back to an electric signal after the transmission. In order to solve this problem, media converters utilizing various light sources and optical fibers have been proposed and are currently being commercially produced.

FIG. 1 is a diagram showing a principle of an optical communication system utilizing conventional media converters. FIG. 2 is a detailed block diagram showing the construction of an optical communication system utilizing conventional media converters.

As shown in FIG. 1, the conventional optical communication system employing the conventional media converters includes an electro-photo converter 20, a photo-electro (or photoelectric) converter 30, and power-supply devices 11, 21, 31, and 41. The electrophoto converter 20 receives an electric signal from a first device 10 having a first electrical interface and converts the electrical signal to an optical signal by means of an optical interface. The photo-electro converter 30 receives the optical signal converted by the electro-photo converter 20, converts the optical signal to the electric signal, and transmits the electric signal to a second device 40 having a second electric interface. The power supply devices 11, 21, 31, and 41 are connected to and supply power to the first device 10, the electro-photo converter 20, the photo-electro converter 30, and the second device 40, respectively. As shown in FIG. 2, each of the first and second devices 10 and 40 includes transmitters Tx⁺ and Tx⁻ for transmitting data and receivers Rx⁺ and Rx⁻ for receiving data. If necessary, both first and second devices 10 and 40 include extra interface devices (NC: Not Connected) which are connected thereto.

The transmitters Tx⁺ and Tx⁻ transmit data for modulation to laser diodes LD of the media converters 20 and 30 through copper wires 1. The receivers Rx⁺ and Rx⁻ receive electric signals converted by photo diodes PD of the media converters 20 and 30.

Each of the media converters 20 and 30 includes a laser diode LD, a photo diode PD, and a power-supply device 21 or 31.

Each of the laser diodes LD receives data from the transmitters Tx⁺ and Tx⁻ of the first or second device 10 or 40 and converts the data into a laser beam, the strength of which is proportional to the level of input data. Then, the laser diode LD transmits the laser beam to the other media converter through an optical fiber 2.

Each of the photo diodes PD receives an optical signal transmitted from the laser diode LD of the other media converter through the optical fiber 2 and outputs an electrical signal proportional in strength to the optical signal, to the receivers Rx⁺ and Rx⁻ of the first or second device 10 or 40, each having an electrical interface.

Further, each of the laser diodes and photo diodes of the media converters requires a control circuit for driving them. The power-supply devices 21 and 31 supply driving power to the control circuits of the media converters.

However, in the conventional optical communication system utilizing media converters—because the construction of the media converter is simple—the media converter can be manufactured in very small sizes. However, the power supply system can not be manufactured in such a small size due to high cost. Therefore, the cost and volume of the media converter increase.

Also, in the conventional optical communication system, an electrical device includes a plurality of communication ports. Accordingly, a plurality of media converters are necessary requiring a plurality of power-supply devices corresponding to the plurality of media converters.

### SUMMARY OF THEE INVENTION

The present invention is to provide a system for supplying driving power to media converters for optical communication, which enables each of the media converters to have a simple and size-reduced construction, each of the media converters converting an interface of an electrical-communication device to an interface of an optical-communication device or converting the interface of an optical-communication device to the interface of an electrical-communication device.

One aspect of the present invention is to provide a system for supplying driving power to media converters for optical communication, which can realize a communication system employing a simple circuit construction at minimal cost even in the case where the communication system includes a plurality of media converters.

According to one embodiment of the present invention, there is provided a system for supplying power to media converters for optical communication, each of which converts an interface of electrical-communication equipment to an interface of an optical-communication device and converts the interface of the optical-communication device to the interface of the electrical-communication device, the system including:

a power-supply device constructed independently from the media converters; and, at least one power-supply socket device to supply power from the power-supply device to the media converters.

According to another embodiment of the present invention, the power-supply socket device includes: a main power-supply socket device for directly receiving power from the power-supply device; at least one dependent power-supply socket device for receiving the power from the main power-supply socket device; and, at least one conductor interface for connecting a dependent power-supply socket device to the main power-supply socket device.

According to yet another embodiment of the present invention, a method for supplying power to media converters for optical communication is provided, each media converter converts an interface of electrical-communication equipment to an interface of an optical-communication device and converts the interface of the optical-communication device to the interface of the electrical-communication device, the method including the steps of: providing a power-supply device constructed independently from the media converters; and, providing at least one power-supply socket device to supply power from the power-supply device to the media converters.

### BRIEF DESCRIPTION OF THE DRAWINGS

FIG. 1 is a diagram showing the principle of an optical-communication system utilizing conventional media converters;

FIG. 2 is a detailed block diagram showing the construction of an optical-communication system utilizing conventional media converters;

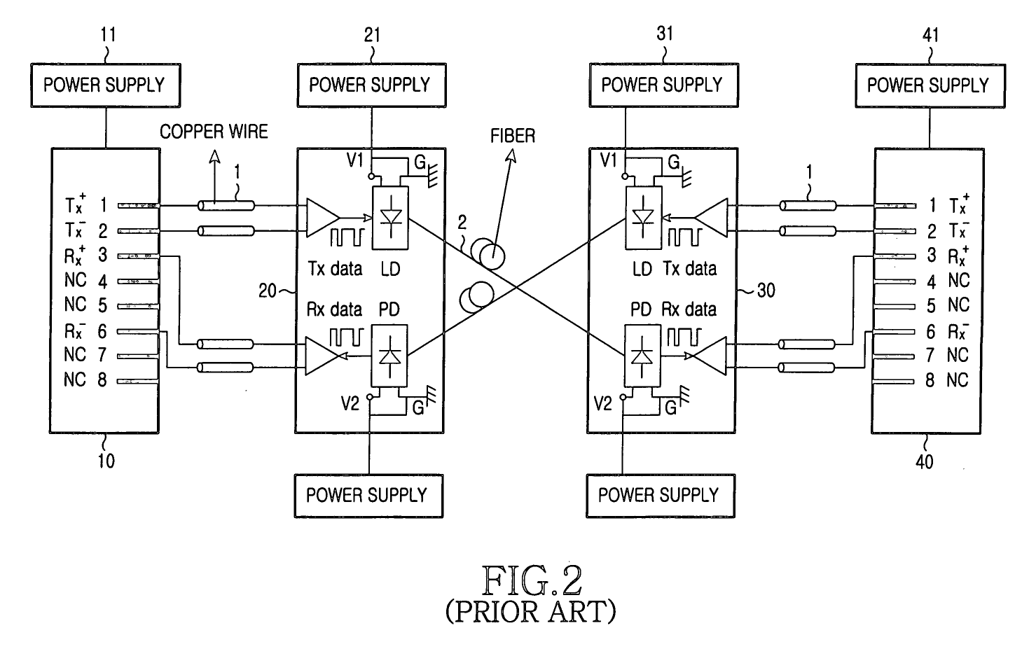

FIG. 3 is a block diagram schematically showing the configuration of an optical-communication system employing power-supply devices for media converters according to the present invention;

FIG. 4 is a block diagram showing in detail the partial configuration of an optical-communication system employing power-supply devices for media converters according to the present invention;

FIG. 5 is a block diagram showing the configuration of an extended optical-communication system having the power-supply device of a media converter according to the present invention; and,

FIG. 6 is a view for showing a configuration of the power-supply device of a media converter employed in an extended optical communication system according to the present invention.

### DETAILED DESCRIPTION OF THE PREFERRED EMBODIMENT

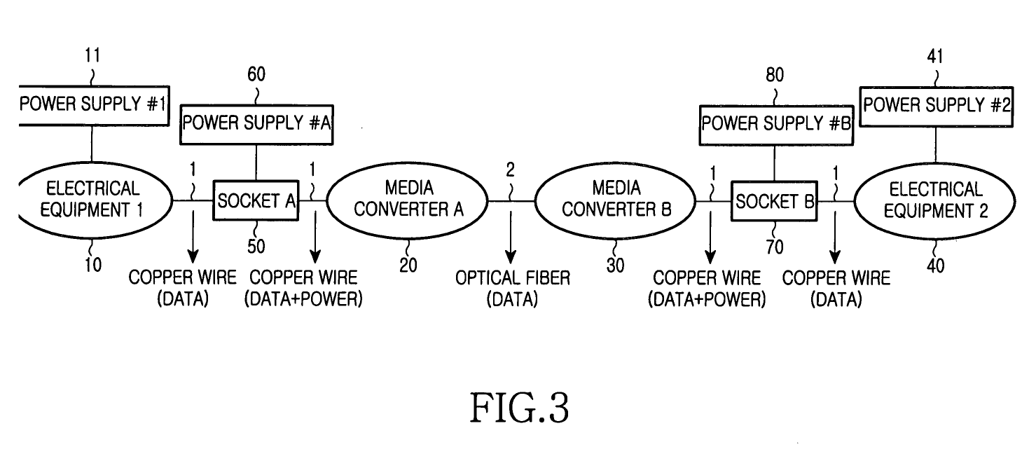

In accordance with the present invention, preferred embodiments of the present invention will be described with reference to the accompanying FIGS. 3 to 6. In the drawings, the same element, although depicted in different drawings, will be designated by the same reference numeral or character. For the purposes of clarity and simplicity, a detailed description of known functions and configurations incorporated herein will be omitted as it may make the subject matter of the present invention unclear.

FIG. 3 is a block diagram schematically showing a configuration of an optical communication system employing power-supply devices for media converters according to the present invention.

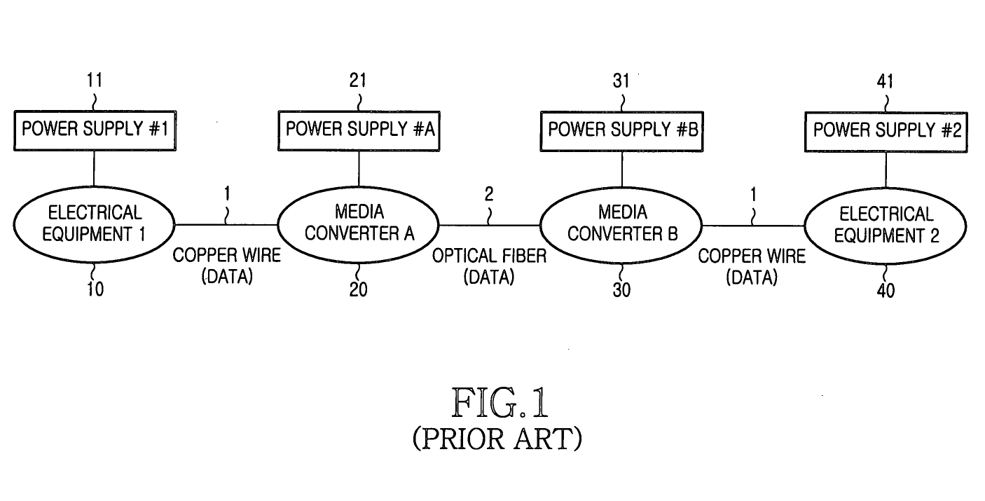

As shown FIG. 3, the optical communication system includes electrical-communication equipment 10 and 40, media converters 20 and 30, and power-supply devices 11, 60, 80, and 41. The power-supply devices 11, 60, 80, and 41 supply power to the electrical-communication equipment 10 and 40, and the media converters 20 and 30, respectively. The configuration of the optical communication system according to the present invention is similar to that of FIG. 1. The media converters 20 and 30 act as electro-photo converters when they receive and convert an electrical signal into an optical interface. Otherwise, the media converters 20 and 30 act as photo-electro converters when they receive and convert an optical signal into an electrical signal. As shown in FIG. 3, the power-supply devices 60 and 80 are constructed separately from the media converters as sockets 50 and 70. The conventional optical communication system shown in FIG. 1 does not have such a feature. The sockets 50 and 70, which are additional, separate power-supply devices, have an input/output data interface for connection with the electrical-communication equipment 10 and 40, and have an input/output data interface and a power-supply interface for connection with the media converters 20 and 30. In this case, the interfacing is carried out by conductive lines such as the copper wires 1.

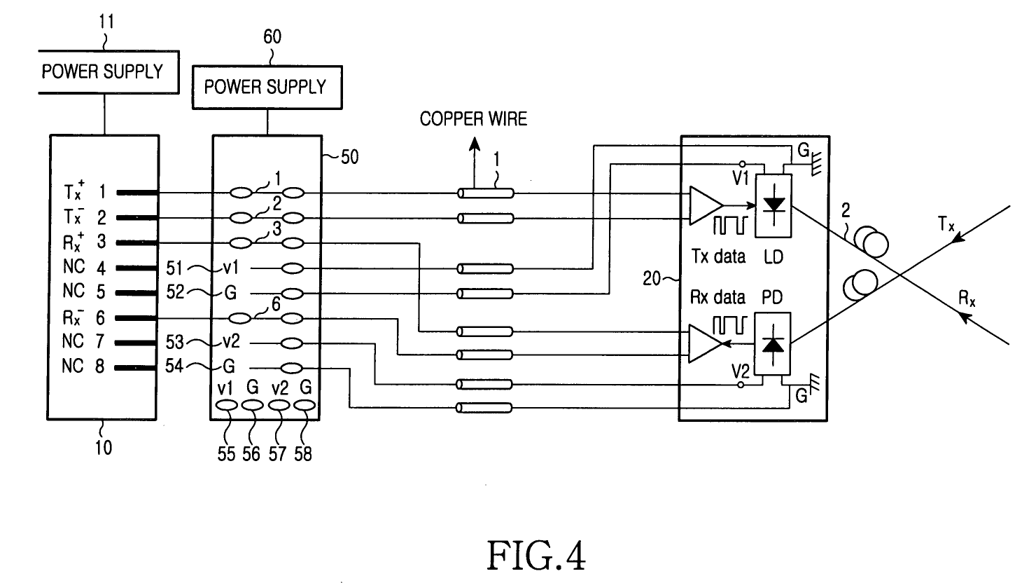

FIG. 4 is a block diagram showing in detail a partial configuration of an optical communication system employing power-supply devices for media converters according to the present invention.

As shown in FIG. 4, an electrical-communication device 10 includes transmitters Tx⁺ and Tx⁻ for transmitting data and receivers Rx⁺ and Rhu − for receiving data. If necessary, the electrical-communication device 10 includes extra interface devices (NC: Not Connected) which are thereto connected.

The transmitters Tx⁺ and Tx⁻ transmit data for modulation to a laser diode LD of the media converter 20 through the copper wires 1. The receivers Rx⁺ and Rx⁻ receive an electrical signal converted by a photo diode PD of the media converter 20. The media converter 20 includes a laser diode LD, a photo diode PD, and an amplifier.

The laser diode LD receives data from the transmitters Tx⁺ and Tx⁻ of the electrical-communication equipment 10 and converts the data into a laser beam, the strength of which is proportional to the level of input data. Then, the laser diode LD transmits the laser beam to the corresponding media converter 30 through an optical fiber 2.

The photo diode PD receives an optical signal transmitted from the laser diode LD of the corresponding media converter through the optical fiber 2 and outputs an electrical signal proportional in strength to the optical signal to the receivers Rx⁺ and Rx⁻ of the electrical-communication equipment 10.

As described above, each of the laser diodes and photo diodes of the media converters requires a power-supply device to supply power to operate each of them.

The power-supply socket device 50, which is another separate power-supply device, includes a plurality of copper wires for electrical interfacing.

The power-supply socket device 50 includes an interface for connection with the media converter 20 and an interface for connection with the electrical equipment 10. These interfaces accommodate the copper wires 1, wherein the power-supply socket device 50 transmits transmission data received from the transmitters T⁺ and T⁻ of the electrical equipment 10 to a laser diode LD of the media converter 20 and also to receive data transmitted from a photo diode PD of the media converter 20 to the receivers Rx⁺ and Rx⁻ of the electrical equipment 10.

Also, the power-supply socket device 50 has V1, G, V2, and G terminals 51, 52, 53, and 54, through which power for driving the laser diode or the photo diode of the media converter can be supplied from V1, G, V2, and G terminals of the power-supply device 60 which will be described later.

In FIG. 4, the V1, G, V2, and G terminals 55, 56, 57, and 58 are terminals for interfacing with an additional power-supply socket device. That is, when an optical communication system is extended, a plurality of dependent power-supply socket devices may be connected to one main power-supply socket device, and there may be provided a conductor interface for connection between the main power-supply socket device and the dependent power-supply socket device, or between the dependent power-supply socket devices.

The power supply device 60 supplies power to the media converter 20. The power-supply device 60 is not directly connected to the media converter 20 but is connected to the power-supply socket device 50, so that the power-supply device 60 supplies power to the media converter 20 through the power-supply socket 50.

As stated above, the socket 50, which is an independent power-supply device, has connection interfaces formed as conductors 1, 2, 3, and 6 through which data are inputted and outputted and power-supply interfaces v1, v2, and G through which power is supplied to the media converter. Moreover, the separate power-supply device 50 includes interfaces 55, 56, 57, and 58 for connections with other sockets.

In FIG. 4, the reference numeral 11 designates a power-supply device for supplying power to the electrical-communication device 10.

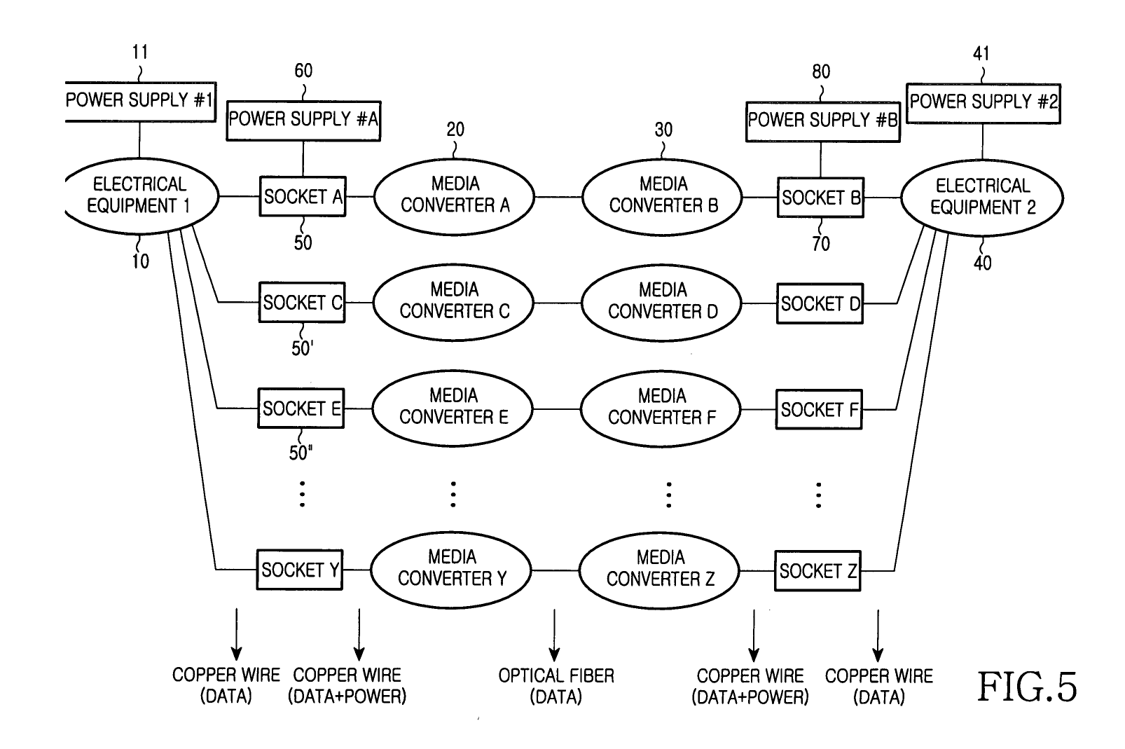

FIG. 5 is a block diagram showing the configuration of an extended optical communication system having the power-supply device of a media converter according to the present invention.

When the electrical device of the communication system is a device such as a switch or a router, which includes a plurality of electrical-communication interfaces, the communication system requires the same number of media converters. In this case, as shown in FIG. 5, a plurality of dependent power-supply socket devices 50′, 50″, 70′, and 70″ may be connected to main power-supply devices 50 and 70, respectively, which are directly connected to power-supply devices 60 and 80, respectively. In the extended optical communication system described above, since the power-supply devices located between the electrical-communication device 10 and the media converter 20 may use a single power source, only one single power-supply device 60 may be an active power-supply device capable of supplying power by itself while the other power-supply devices 50, 50′, and 50″ may utilize power supplied through interfaces from the single power-supply device 60. Accordingly, even when the electrical device of the communication system includes a plurality of electrical-communication interfaces, only one power-supply device may be an active power-supply device while the other power-supply devices may be passive power-supply devices utilizing conductors in the communication system. When each of the media converters is connected to an independent active power-supply device, as is in the conventional optical communication system, the entire communication system requires greater volume and cost and is inefficient in its necessary function.

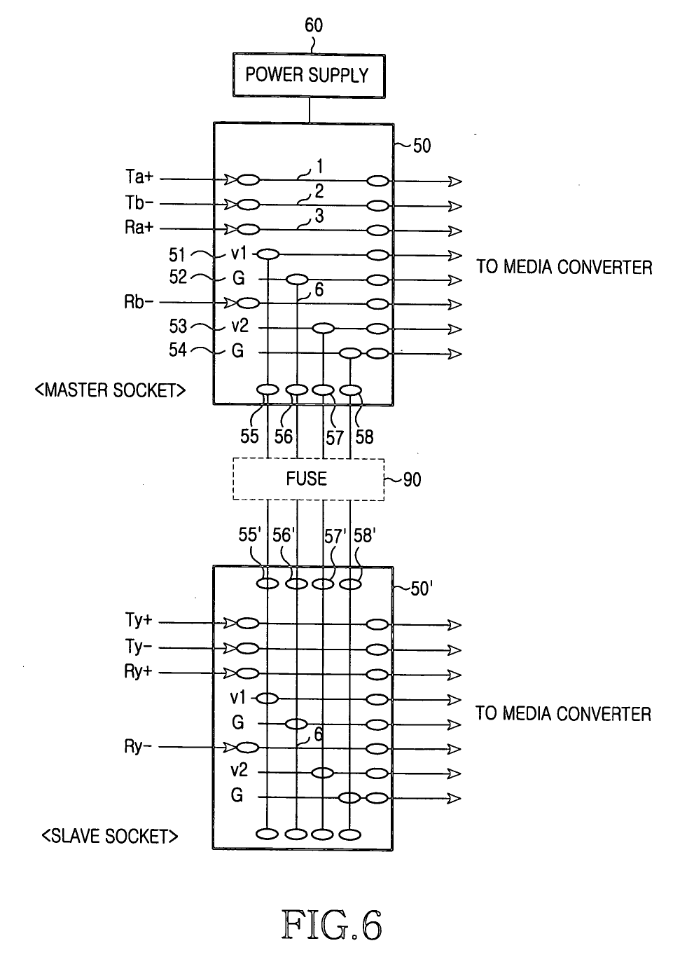

FIG. 6 is a view for showing the configuration of a power-supply device of a media converter employed in an extended optical communication system according to the present invention.

As shown in FIG. 6, when the electrical device of the communication system includes a plurality of media converters, necessary power may be supplied to the media converters by means of a power-supply device 60 and a plurality of power-supply socket devices 50 and 50′ in the communication system. In this case, the power-supply device 60 generates sufficient power in driving circuits in the media converters. The power-supply socket devices 50 and 50′ may include passive circuits 1, 2, 3, 6, 51, 52, 53, 54, 55, 56, 57, and 58. Further, a device such as a fuse 90 may be interposed between the power-supply socket devices 50 and 50′, so as to prevent a short-circuit, thereby preventing the power-supply devices from functioning out of order.

In a communication system according to the present invention, wherein the electrical device includes a plurality of electrical-communication interfaces, only one power-supply device must be an active power-supply device while the other power-supply devices may be passive power-supply devices utilizing conductors. Consequently, the entire communication system may be constructed in a smaller sizeand operate more efficiently. Further, in the communication system according to the present invention, a device such as a fuse 90 may be interposed between the power-supply socket devices 50 and 50′, so as to prevent a short-circuit, thereby preventing the power-supply devices from functioning out of order.

While the invention has been shown and described with reference to certain preferred embodiments thereof, it will be understood by those skilled in the art that various changes in form and details may be made therein without departing from the spirit and scope of the invention as defined by the appended claims. Therefore, this invention is not to be unduly limited to the embodiment set forth herein, but to be defined by the appended claims and equivalents thereof.

What is claimed is:

1. A system for supplying power to media converters for optical communication, wherein each media converter converts an interface of electrical-communication equipment to an interface of an optical-communication device and converts the interface of the optical-communication device to the interface of the electrical-communication device, the system comprising:
a power-supply device constructed independently from the media converters; and,
at least one power-supply socket device to supply power from the power-supply device to the media converters, wherein
the power-supply socket device includes input/output data interfaces for connection with the electrical-communication equipment and further includes input/output data interfaces and power-supply interfaces for connection with the media converters.

2. The system as claimed in claim 1, wherein the power-supply socket device further comprises:
a main power-supply socket device for directly receiving power from the power supply device;
at least one dependent power-supply socket device for receiving the power from the main power-supply socket device; and,
at least one conductor interface for connecting a dependent power-supply socket device to the main power-supply socket device.

3. The system as claimed in claim 2, wherein the at least one conductor interface alternatively connects a dependent power-supply socket device to another dependent power-supply socket device.

4. The system as claimed in claim 1, further comprising a fuse interposed between the conductor interfaces to prevent the conductor interfaces from a short circuit.

5. The system as claimed in claim 1, wherein the electrical-communication equipment further includes additional interfaces that accommodate additional interface devices.

6. The system as claimed in claim 1, wherein the electrical-communication equipment transmits electrical signals to and from media converters through copper wire.

7. The system as claimed in claim 1, wherein the power-supply socket devices transmit power to the media converters through copper wire.

8. The system as claimed in claim 1, wherein the media converters transmit optical data between one another through optical fiber.

9. The system as claimed in claim 1, wherein the media converters comprise an amplifier, a laser diode, and a photodiode.

10. A method for supplying power to media converters for optical communication, wherein each media converter converts an interface of electrical-communication equipment to an interface of an optical-communication device and converts the interface of the optical-communication device to the interface of the electrical-communication device, the method comprising the steps of:
providing a power-supply device constructed independently from the media converters; and,
providing at least one power-supply socket device to supply power from the power-supply device to the media converters.

11. The method as claimed in claim 10, wherein the step of providing a power-supply socket device further includes the step of providing a power-supply socket device including input/output data interfaces for connection with the electrical-communication equipment and input/output data interfaces and power-supply interfaces for connection with the media converters.

12. The method as claimed in claim 11, wherein the step of providing a power-supply socket device further comprises the steps of:
providing a main power-supply socket device for directly receiving power from the power-supply device;
providing at least one dependent power-supply socket device for receiving the power from the main power-supply socket device; and,
providing at least one conductor interface for connecting a dependent power-supply socket device to the main power-supply socket device or for connecting one dependent power-supply socket device to another dependent power-supply socket device.
